(19) United States
(12) Patent Application Publication
(10) Pub. No.: US 2004/0199828 A1
(43) Pub. Date: Oct. 7, 2004

(54) Method and apparatus for tracing troubleshooting events for aiding technical assistance

(75) Inventors: Rafael Graniello Cabezas, Austin, TX (US); Anh Tuan Dang, Austin, TX (US); Jason Eric Moore, Austin, TX (US); Elizabeth Silvia, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/405,375

(22) Filed: Apr. 1, 2003

(51) Int. Cl. G06F 11/00

(52) U.S. Cl. 714/39

(57) ABSTRACT

A method and apparatus for tracing troubleshooting events for aiding technical assistance personnel are provided. With the method and apparatus, a user initiates a technical assistance tracing mechanism on his/her client device. The technical assistance tracing mechanism includes event listeners that are registered with the operating system of the client device. These event listeners are notified when, for example, an input device event occurs, when a graphical user interface event occurs, and the like. These events are recorded by the technical assistance tracing mechanism of the present invention as a log of events. This log of events may then be provided to a computing device which is being used by the technical assistance specialist for use in diagnosing and curing the problems encountered by the user. An automated tool may be provided for analyzing the event log and/or emulating an operating system environment so that the event log may be replayed in a graphical manner.

### BACKGROUND OF THE INVENTION

1. Technical Field

The present invention is directed to a method and apparatus for tracing troubleshooting events in order to aid technical assistance personnel in ascertaining the source of a problem and determining corrective action.

2. Description of Related Art

Currently, when a user makes use of a technical support line or on-line technical support, the user must interface with human technical support personnel to try and ascertain the source of a problem existing in the user's computing device and determine how to correct that problem. The communication between the technical support personnel and the user typically takes the form of the user explaining the problem being experienced and the technical support person guiding the user through a series of checks and operations to attempt to diagnose the problem and correct the operation of the computing device. The technical support person must try to interpret the user's description of the problem being experienced and must be able to explain how to perform the checks and operations to diagnose and cure the problem.

Because there is no ability for the technical support person to monitor what the user is doing in response to the instructions he/she gives the user, the technical support person must rely on the descriptions provided by the user to deduce whether the user is following the instructions correctly and what the result of performing the operations is. Thus, there is a vast source of possible misinterpretation between the user and the technical assistance personnel. As a result, the time and aggravation experienced by the user and the technical assistance personnel is increased.

It would be beneficial to have an apparatus and method for tracing troubleshooting events for aiding technical assistance personnel in diagnosing and curing problems encountered by users of computing devices.

### SUMMARY OF THE INVENTION

The present invention provides a method and apparatus for tracing troubleshooting events for aiding technical assistance personnel. With the method and apparatus of the present invention, a user initiates a technical assistance tracing mechanism on his/her client device. The technical assistance tracing mechanism includes event listeners that are registered with the operating system of the client device. These event listeners are notified when, for example, an input device event occurs, when a graphical user interface event occurs, and the like.

These events are recorded by the technical assistance tracing mechanism of the present invention as a log of events. This log of events may then be uploaded to a technical assistance server. As part of the log of events, a client device identifier may be included in the log of events so that technical assistance personnel may identify the log of events for a user that is currently being helped by that technical assistance specialist.

When a technical assistance specialist wishes to retrieve the log of events for the user, the technical assistance specialist may enter a user identifier and have the technical assistance server search for a corresponding log of events for that user. The log of events may then be downloaded to the computing device which is being used by the technical assistance specialist for use in diagnosing and curing the problems encountered by the user.

In diagnosing and curing the problems encountered by the user, the technical assistance specialist may him/herself look at the event log and determine where the problem may lie or he/she may use an automated tool for analyzing the event log. The automated tool may include a event log analyzer that looks at the sequence of events in the event log and determines if there are any error events in the event log. Based on these error events, the event log analyzer may determine possible sources of the corresponding error. Each of these possible sources may be investigated by comparing the sequence of other events in the event log to established patterns. Based on similarities and/or differences with these established patterns, the possible source of the error may be identified. Alternatively, if no error event is present in the event log, the pattern comparison may be performed to determine sequences of events in the event log that may indicate a source of an error.

As another level of analysis, the automated tool may include an operating environment emulator that emulates the operating environment of the client computing device. With the operating environment emulator, the event log is loaded into the operating environment emulator which then graphically depicts the events of the event log with corresponding dialog boxes explaining the event. Controls may be provided for use by the technical assistance specialist so that the specialist may pause, advance, slow down, speed up, or otherwise change the rate at which the sequence of events in the event log is graphically depicted. In this way, the technical assistance specialist is provided with a view of the operating environment as the user saw it with helpful commentary added to aid the specialist. By displaying the events in this manner, the technical assistance specialist may be able to determine whether the user or the computing device was the source of the error and more accurately identify the probable source of the error.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary block diagram of a server computing device in accordance with the present invention;

FIG. 3 is an exemplary block diagram of a client computing device in accordance with the present invention;

FIG. 4 is an exemplary block diagram illustrating the primary operational components of a server and a client device in accordance with the present invention;

FIG. 5 is an exemplary diagram illustrating an exemplary event log entry according to the present invention;

FIGS. 6A-B illustrate a series of graphical user interface output screens in which the events of an event log are emulated in accordance with the present invention; and

FIG. 7 is a flowchart outlining an exemplary operation of the present invention.

### DETAILED DESCRIPTION OF THE PREFERRED EMBODIMENT

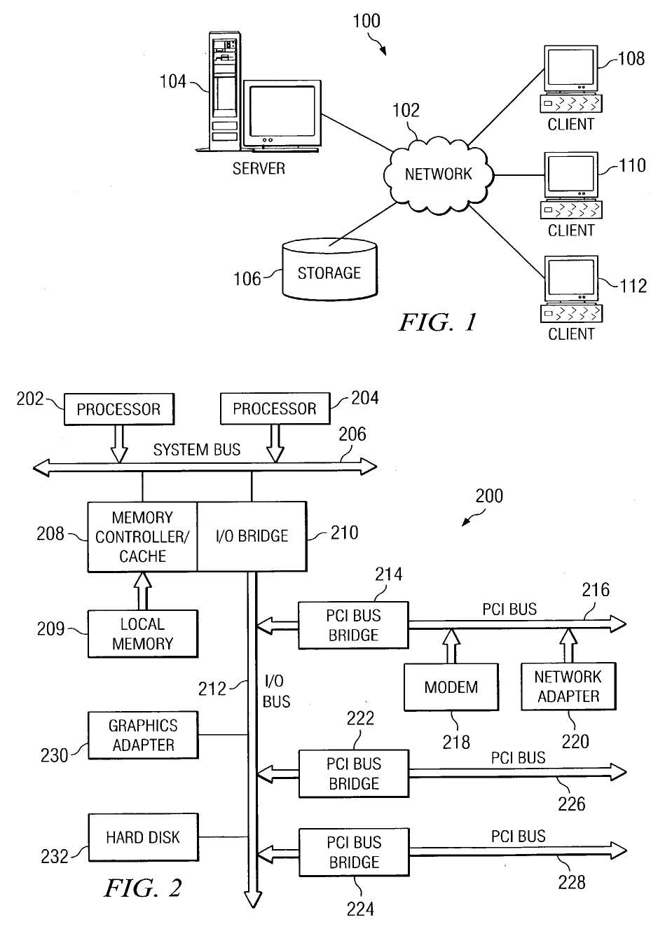

As mentioned above, the present invention provides a mechanism for generating a trace file of user and computer system generated events which is uploaded to a technical assistance server for use by technical assistance personnel in diagnosing the source of the problem being experienced by the user and determining a solution to the problem. As such, the present invention is most beneficially used in conjunction with a distributed data processing system. Thus, FIGS. 1-3, described hereafter, are provided as example computing environments in which one or more components of the present invention may operate.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

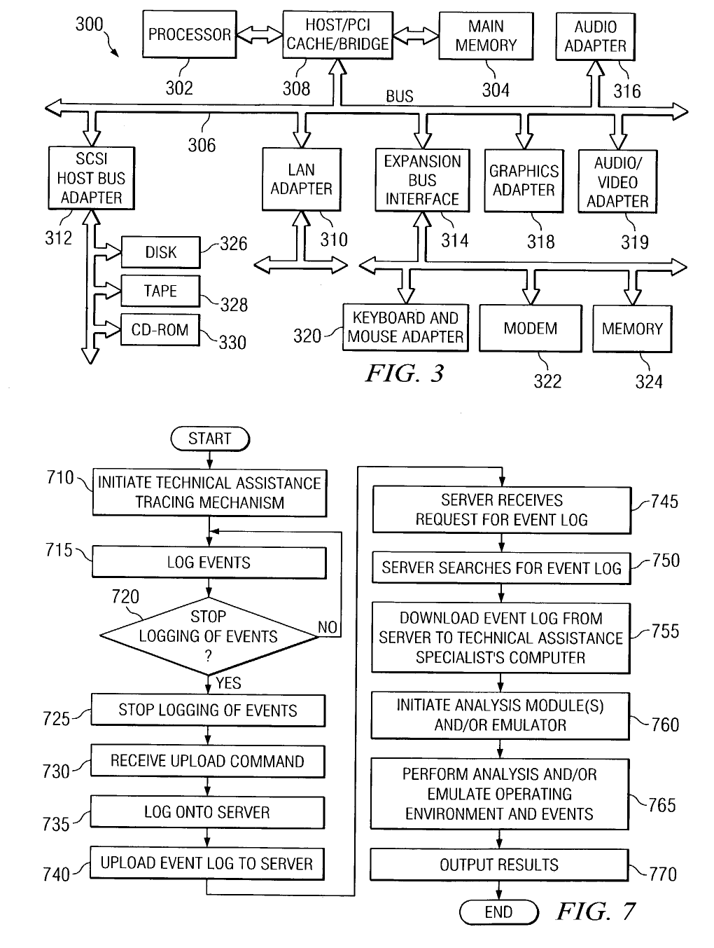

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Referring again to FIG. 1, the present invention provides a method and apparatus for tracing troubleshooting events for aiding technical assistance personnel. With the present invention, a first client device, e.g., client 108, may be a computing device of a user that wishes to obtain technical assistance with a problem being experienced with the computing device. A second client device, e.g., client 110, may be associated with a technical assistance specialist that is capable of providing the technical assistance desired by the user of the client 108. A server, such as server 104, is provided for providing a data communication pathway between client 108 and technical assistance client 110. As will be described in detail hereafter, with the present invention, the client 108 generates and sends event logs to the client 110 via the server 104. These event logs may then be used by the technical assistance specialist operating client 110 to diagnose and solve the problem being experienced on client 108.

With the method and apparatus of the present invention, a user initiates a technical assistance tracing mechanism on his/her client device. The technical assistance tracing mechanism may be initiated before or during a call, or log on, to a technical assistance specialist workstation. Once initiated, the technical assistance tracing mechanism of the present invention records all events that occur within the operating system environment of the client device.

In a preferred embodiment, the events that occur are identified using event listeners that are registered with the operating system. These event listeners receive notification of events occurring and provide the information to event handlers which perform operations based on the events. In addition, these event listeners add an entry of the event to an event log that is maintained by the technical assistance tracing mechanism of the present invention.

Examples of event listeners include action listeners, window listeners, mouse listeners, mouse motion listeners, component listeners, focus listeners, list selection listeners, and the like. An action listener receives notification of events such as when a user clicks a button, presses return while typing in a text field, chooses a menu item, and the like. A window listener receives a notification when a frame, e.g., a main window, is closed or opened by a user operation. A mouse listener receives notifications when a user presses a mouse button while the cursor is over a component of the operating system environment, for example. A mouse motion listener receives a notification when the user moves the mouse over a component of the operating system environment, for example. A component listener receives a notification when a component of the operating system environment is displayed, for example. A focus listener receives a notification when the focus, i.e. the presently active window, changes, for example. The list selection listener is notified when a table or list selection changes, for example. These and other event listeners may be used with the technical assistance tracing mechanism of the present invention.

In addition to events notified to the event listeners of the technical assistance tracing mechanism, the present invention includes error event listeners which are notified when an error occurs. In the case of an error, the error event is notified to the error event listeners which in turn generate an event log entry for the error in the event log maintained by the technical assistance tracing mechanism.

As previously stated, the events generated by the user and/or the computing device are recorded by the technical assistance tracing mechanism of the present invention as a log of events, or event log. This event log includes event entries that contain information identifying, for example, the source of the event, the type of event, the time of the event, the components of the operating system environment associated with the event and other parameters necessary for ascertaining the nature of the event and, in some embodiments, necessary for emulating the event, as discussed hereafter. In addition, as part of the log of events, a client device identifier may be included in the event log so that technical assistance personnel may identify the event log for a user that is currently being helped by that technical assistance specialist.

The event log is updated with each new event that is notified to one or more of the event listeners associated with the technical assistance tracing mechanism until the user indicates that the tracing is to be terminated. The resulting event log may then be uploaded to a technical assistance server, e.g., server 104, where it is stored in a secure manner such that only technical assistance specialists who are associated with the owner/operator of the technical assistance server may have access to the event logs. The uploading of the event log may include providing a graphical/textual representation of the event log to the user of the client device 108 prior to sending of the event log to the technical assistance server 104 in order to allow the user to confirm that the information contained therein is approved for sending to the technical assistance server 104. If the user identifies information in the event log that the user wishes to remove, an editor may be provided for removing the information or otherwise making the information non-viewable by other persons, e.g., replacing the information with “*” characters.

When a technical assistance specialist wishes to retrieve the log of events for the user, the technical assistance specialist may enter a user identifier and into a graphical user interface provided on his/her computing device. This user identifier is sent along with a request to retrieve the event log for the designated user identifier. As a result, the server searches the database of stored event logs to identify an event log having the designated user identifier. The corresponding event log is then downloaded to the technical assistance specialist's computing device. This event log is then used by the technical assistance specialist to ascertain the possible sources and remedies for the problems being experienced by the user of the client device 108.

Alternatively, a user interface may be provided on the technical assistance specialist's computing device for accessing the event log without downloading the event log. Furthermore, the analysis devices discussed hereafter may be resident on the server rather than the technical assistance specialist's computing device such that the technical assistance specialist is provided with an applet, or the like, for interfacing with these analysis devices. In such a case, the operations that are discussed hereafter are performed in the server and the results, e.g., graphical/textual displays, are sent to the technical assistance specialist's computing device for his/her use in aiding the user of the client device 108 in solving the problem.

In analyzing the event log that is downloaded by the technical assistance specialist's computing device, an event analysis engine is utilized for parsing through the event log to identify any error events that may have occurred. The information stored in the event log detailing the source of the error event, the components of the operating system environment associated with the error event, and the like, may be used to ascertain the probable source of the error based on information obtained from an error event database. The error event database may include entries identifying known errors and their related causes. The error event database may include entries similar to the error event entries in the event log and may further include event pattern information identifying event patterns that lead to the error event occurring, for example. Each entry in the error event database may have multiple event patterns which may be checked against the event sequence recorded in the event log to determine which of the possible sources of the error is most likely to be the actual source of the error in the client device 108. Each event pattern may have one or more corresponding probable sources of the error and one or more recommended solutions.

That is, for example, an error event may have a first pattern of events that indicates that a user's operation of the right mouse button on a particular component of the operating system environment leads to the error event being generated. As a result, the error event entry may indicate that the component is associated with the input device driver software and that reinstallation or updating the device driver software is necessary. Alternatively, a second pattern of events that indicates that the opening of a window in the operating system environment having particular attributes leads to the error event occurring. In this case, the same error may have a different source, such as a lack of available RAM or the like. As a result, the error event entry in the database may indicate that the user should shutdown one or more applications that are currently running in the operating system environment or increase the allocation of memory for a particular use. Thus, the same error event may have multiple event patterns that lead to that error event occurring and each may have a different source of the problem.

If the event log for the user does not include an error event, e.g., the user's problem is slow performance, not being able to obtain a certain resolution display, unable to log onto a server, or other problems that do not necessarily generate an error event, for example, then the analysis engine of the present invention may consult an event sequence pattern database to perform a pattern matching to identify the probable source of the problem. The pattern matching may be performed in a similar manner as discussed above with regard to determining which event pattern associated with an error is present in the event log. That is, the sequence of events in the event log may be matched to one or more event patterns in event sequence pattern database to determine a source of the potential problem. The matching pattern entry may then be investigated for the particular problem complained of to determine which source associated with the event pattern is the most probable source of the problem. Associated suggested solutions to the problem may then be retrieved and provided to the technical assistance specialist to aid the technical assistance specialist in helping the user of the client device 108 solve the problem complained of.

The event patterns discussed above may take many different forms. For example, the event patterns may take the form of a list of events, a list of events with designated timing information, source information, related component information and other parameters, a set of rules in a rules database, state machines, or the like. Regardless of the particular form of the event patterns, the present invention determines possible sources of errors or performance problems based on a matching of the event patterns to the event sequence recorded in the event log received from the client device 108.

As another level of analysis, the present invention may include an operating environment emulator that emulates the operating environment of the client computing device. With the operating environment emulator, the event log may be loaded into the operating environment emulator which then graphically depicts the events of the event log with corresponding dialog boxes explaining the events. In order to accurately reflect the operating environment of the client device 108, some configuration information may need to be included in the event log so that the proper operating environment components and other configuration information is accurately represented in the emulator.

The emulator may take the information stored in the event log and recreate the series of events recorded in the event log. These events are sequentially depicted on the technical assistance specialist's computing device in a similar manner as the way they were depicted on the client device 108. In addition, the emulator may include text boxes for each event providing additional explanation information, e.g., “user clicks right mouse button”, “icon dragged and dropped”, or “application initiated.” Controls may be provided in a graphical user interface associated with the emulator for use by the technical assistance specialist in controlling the recreation of the sequence of events, e.g. the technical assistance specialist may pause, advance, slow down, speed up, or otherwise change the rate at which the sequence of events in the event log is graphically depicted. In this way, the technical assistance specialist is provided with a view of the operating environment as the user saw it with helpful commentary added to aid the specialist. By displaying the events in this manner, the technical assistance specialist may be able to determine whether the user or the computing device was the source of the error and more accurately identify the probable source of the error.

The emulation of the event log may be performed at substantially the same time as the event log analysis is performed. That is, the technical assistance specialist may have a first window on his/her computing device open for running the event log analysis discussed above and a second window open for viewing the emulation of the event log. In this way, the technical assistance specialist may both obtain suggestions as to possible sources of the error and solutions as well as view the events that occurred in order to provide the technical assistance specialist with the most information possible in diagnosing and solving the problems complained of by the user of the client device 108.

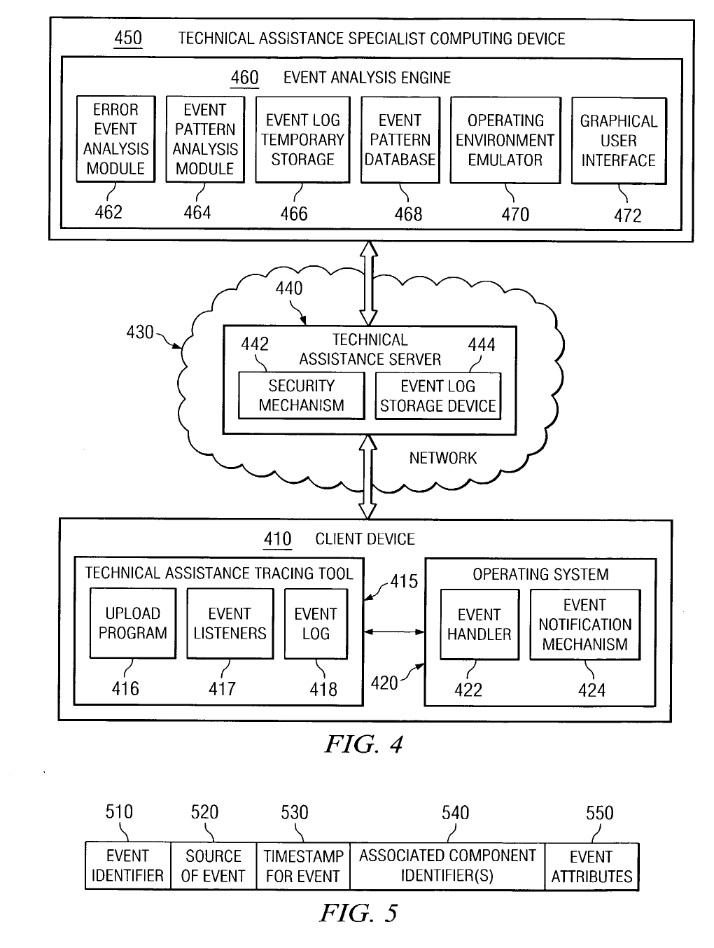

FIG. 4 is an exemplary block diagram illustrating the primary operational components of a technical assistance server, a technical assistance specialist's computing device and a client device in accordance with the present invention. As shown in FIG. 4, a client device 410 is provided with a technical assistance tracing tool 415 and an operating system 420. The technical assistance tracing tool 415 includes an upload program 416, one or more event listeners 417, and an event log storage device 418. The operating system 420 includes, among other elements, one or more event handlers 422 and an event notification mechanism 424.

The event listeners 417 of the technical assistance tracing tool 415 register with the event notification mechanism 424 of the operating system 420 so that events of the type that the listener listens for are notified to the event listener when they occur. The event handlers 422 are utilized to handle the events as they occur.

When an event occurs, the event notification mechanism 424 sends a notification to the appropriate registered event listener 417 in the technical assistance tracing tool 415. The event listener 417 generates an event log entry and stores the event log entry in the event log storage device 418. This process is repeated for each event for which a notification is received until the technical assistance tracing tool 415 is instructed to stop tracing, e.g., by a user input indicating termination of tracing.

When the tracing of events is complete, the user may choose to initiate the upload program 416 of the technical assistance tracing tool 415 to upload the event log from the event log storage device 418 to the technical assistance server 440. The upload program 416 may provide the user of the client device 410 with a graphical/textual representation of the information in the event log so that the user may verify that the event log does not contain sensitive information that should be removed. If the event log does contain sensitive information, the upload program 416 may provide an editor that allows the user to remove or otherwise make such information unviewable.

The upload program 416 may then attempt a log-on with the technical assistance server 440. As part of this log-on process, the security mechanism 442 of the technical assistance server 440 may verify that the user of the client device 410 is eligible to receive technical assistance. Such verification may be based on a user registration database (not shown) in which valid user identifiers are stored that may be compared to the user identifier that was received in the log-on attempt.

If the user is eligible to receive technical assistance, the event log is uploaded to the technical assistance server 440 which stores the event log in the event log storage device 444. The event log may be stored in the event log storage device 444 in such a manner that the user identifier may be used to locate the event log. For example, the event log may be stored in a data structure that is indexed by user identifier.

The above process of generating an event log and uploading the event log to the technical assistance server 440 may be performed before or during a user's session with a technical assistance specialist. A “session” as it is used herein, means an communication connection has been established and is currently active between the user of the client device 410 and the technical assistance specialist that is using the technical assistance specialist computing device 450. This communication connection may be a data link over network 430, a telephone call to a technical assistance help line, or the like. At some time during the session, the technical assistance specialist may retrieve the event log from the event log storage device 444 and use it with the event analysis engine 460 to obtain greater information about the problem being experienced by the user.

During a session, the technical assistance specialist may determine that it would be beneficial to retrieve the event log for a user's client device 410 from the technical assistance server 440 in order to obtain a better understanding of the problem being experienced by the user. In such a case, the technical assistance specialist may, through graphical user interface 472, generate a request to retrieve the event log of the user from the event log storage device 444. This request is sent to the technical assistance server 440 which, using security mechanism 442, verifies that the technical assistance specialist computing device 450 is authorized to retrieve the requested event log. If the technical assistance specialist computing device 450 is authorized, the technical assistance server 440 searches the event log storage device 444 for an event log matching the user identifier sent in the request from the technical assistance specialist computing device 450. The corresponding event log is then sent to the technical assistance specialist computing device 450 if found. Otherwise, the technical assistance specialist computing device 450 is informed that no matching event log exists.

The event log received from the technical assistance specialist server 440 is temporarily stored in the event log temporary storage 466. An acknowledgement that the event log has been received may be provided to the technical assistance specialist via the graphical user interface 472. The technical assistance specialist may then initiate the error event analysis module 462, event pattern analysis module 464, and/or operating environment emulator 470 to perform analysis on the event log stored in the event log temporary storage 466.

The error event analysis module 462 is used to search the event log for any error events that may be present. It an error event is identified, the error event analysis module 462 retrieves an entry from the event pattern database 468 corresponding to the identified error event. If the entry that is retrieved contains multiple possible sources of the error, the error event analysis module 462 may initiate the event pattern analysis module 464 which analyzes the pattern of events present in the event log and compares them to the patterns of events associated with each possible source of error in the event entry retrieved from the event patter database 468. If a match is identified, the matching entry's source and suggested solutions are output to the technical assistance specialist via the graphical user interface 472.

If an error event is not identified in the event log, the event pattern analysis module 464 may be utilized to match the pattern of events in the event log to event entries in the event pattern database 468. If a matching pattern is identified, the matching entry's source and suggested solutions may be output to the technical assistance specialist via the graphical user interface 472.

As mentioned above, the entries in the event pattern database 468 may take many different forms including database entries, rule sets, state machines, and the like. In this way, a correspondence between a pattern of events and a problem may be represented. In addition, a source of the problem and possible solutions may be associated with the correspondence between the pattern of events and the problem. Based on the pattern of events, an entry may be identified and, based on the correspondence, a problem, its most probable source, and suggested solutions may be identified.

The operating environment emulator 470 may be used by the technical assistance specialist in order to obtain a better understanding of what the user of the client device 410 experienced during the time period represented by the event log. The operating environment emulator 470 may take configuration information stored in association with the event log received from the client device 410 to emulate an operating environment similar to that of client device 410. The emulated operating environment may then be used to graphically and textually recreate the events of the event log. That is, each mouse movement, button press, component addition, component selection, and the like, may be depicted in this emulated operating environment in the sequence detailed in the event log.

In addition, the operating environment emulator 470 may take event entries in the event log and generate textual help messages based on these event entries which are displayed as the event is depicted in the emulated operating environment. For example, if an event is a component selection, the operating environment emulator 470 may graphically illustrate the mouse cursor of the operating environment being moved over a component of the operating environment and a text box may be displayed stating “component selection.”

As mentioned above, the operating environment emulator 470 depicts the events in the event log in the sequence designated in the event log. The rate at which these events are depicted may be controlled by the technical assistance specialist via the graphical user interface 472. That is, controls may be provided via the graphical user interface 472 for pausing, stopping, resuming, reverse, increasing or decreasing speed, and the like, of the recreation of the events using the emulated operating environment. In this way, the technical assistance specialist may control the recreation of the events so that he/she may concentrate more closely on certain portions of the events as opposed to other portions of the recreated events.

Based on the tools provided by the event analysis engine of the present invention, the technical assistance specialist is provided with an increased amount of information about the client device 410, the events surrounding a problem experienced by the user of the client device 410, and the operating environment experienced by the user of the client device 410. This information leads to a more informed technical assistance specialist who may then be able to more quickly and precisely identify the probable source of the problem being experienced by the user and determine the appropriate solution.

FIG. 5 is an exemplary diagram illustrating an exemplary event log entry according to the present invention. As shown in FIG. 5, the event log entry includes an event identifier 510, an identifier of the source of the event 520, a timestamp of the event 530, zero or more associated component identifiers 540, and zero or more other event attributes 550. The event identifier 510 identifies the type of event that was generated based on the information obtained from the event listener. The source of the event identifier identifies what application, hardware, or other software component of the client device generated the event. The timestamp for the event 530 identifies the system time at which the event occurred. The associated component identifier(s) 540, if any, identify what components of the operating environment are associated with the event. The event attributes 550, if any, identify other attributes of the event that may be used in analysis of the event by a technical assistance specialist's event analysis engine or may be used in emulating the event in an emulated operating environment.

Of course it should be appreciated that FIG. 5 is only intended to be exemplary and is not intended to imply any limitation as to the format of the event log entry or the particular information that is or must be included in the event log entry. Many modifications, as will become apparent to those of ordinary skill in the art in view of this description, may be made without departing from the spirit and scope of the present invention.

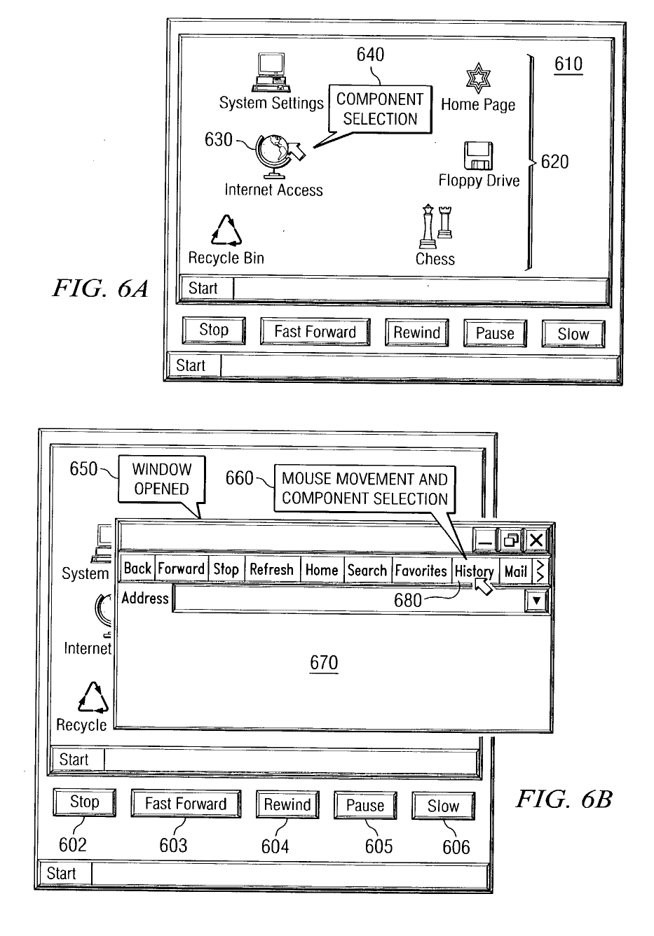

FIGS. 6A-B illustrate a series of graphical user interface output screens in which the events of an event log are emulated in accordance with the present invention. FIG. 6A illustrates a display of an emulated operating environment, e.g., a Microsoft Windows™ operating environment. As shown in FIG. 6A, the emulation of the operating environment includes providing a graphical user interface 610 having components 620 similar to that of the client device from which the event log was received. The information about which operating environment, components of the operating environment, and other configuration information may be obtained from the client device 410 in a configuration file associated with the event log. The configuration file may be generated, for example, from system registries, device manager information, icon registries, and the like, of the client device 410.

The components 620 of the operating environment are emulated in the emulated operating environment. After having emulated the operating environment 610 and the components 620 of the operating environment, the operating environment emulator of the present invention steps through the event log in sequential order displaying the events graphically. Thus, for example, if the first event in the event log is selection of the “Internet Access” icon 630 of the operating environment using the computer mouse, the emulator of the present invention graphically depicts the mouse cursor (the depicted arrow) being placed over the “Internet Access” component 630 of the emulated operating environment. As a helpful commentary for determining the event that is occurring with regard to the “Internet Access” component 630, a dialog box 640 may appear indicating the event that is occurring.

As illustrated in FIG. 6B, multiple dialog boxes 650 and 660 may be present in the emulated operating environment in order to provide a complete understanding of the events that are occurring in the emulated operating environment. As shown in FIG. 6B, in response to the selection of the “Internet Access” component 630, a browser window 670 is opened and a dialog box 650 is displayed indicating the event as being “Window Opened.” Thereafter, the event log indicates that the user moved the mouse pointer to the “History” icon 680 in the browser window 670. As a result, the emulator of the present invention will depict the mouse cursor moving to the “History” icon 680 with the dialog box 660 indicating “mouse movement and component selection.” The remainder of the events in the event log will be depicted using the emulator of the present invention in a similar manner.

In addition to providing the emulated operating environment, the emulator of the present invention provides graphical user interface controls 602-606 for controlling the rate at which the events are traversed in the event log. In the depicted example, the graphical user interface controls 602-606 resemble the “stop”, “fast forward”, “rewind”, “pause” and “slow” operations of a video cassette recorder. This is only an example of the graphical user interface controls and other operations may be provided as controls in addition to or in replacement of one or more of the depicted controls without departing from the spirit and scope of the present invention.

In addition other controls may be provided for controlling the emulation of the events that do not only control the speed of the event emulation. For example, additional controls may be provided for designating the types of events that should be depicted, the level of dialog box detail that is to be provided, the manner by which certain events are depicted, and the like.

Thus, with the event analysis modules and operating environment emulator of the present invention, the technical assistance specialist may be provided with a more complete understanding of what has occurred at the client device to cause the user to request technical assistance. In this way, the technical assistance specialist may deduce the probable source of the problems complained of and instruct the user, either by way of a data or telephone communication connection, how to resolve the problem.

FIG. 7 is a flowchart that illustrates the overall operation of the present invention from a system level. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

FIG. 7 is a flowchart outlining an exemplary operation of the present invention. As shown in FIG. 7, the operation starts with initiation of the technical assistance tracing mechanism (step 710). Thereafter, events are logged in an event log (step 715) until a stop condition occurs (steps 720-725). An upload command is received (step 730). The client device logs onto the technical assistance server (step 735) and the event log is uploaded to the technical assistance server (step 740).

The technical assistance server then receives a request from a technical assistance specialist computing device for an event log corresponding to the user of the client device (step 745). The technical assistance server searches its store of event logs to find the event log corresponding to the identified user (step 750) and downloads the event log to the technical assistance specialist computing device (step 755). Thereafter, the technical assistance specialist initiates one or more of the analysis modules and the operating environment emulator (step 760). Analysis is then performed and/or the operating environment and events in the event log are emulated (step 765). The results of the analysis and the emulation are then provided to the technical assistance specialist via a graphical user interface of the technical assistance specialist computing device computing device (step 770) and the operation ends.

Thus, the present invention provides a mechanism for recording events in a client device that may be used in troubleshooting a problem being experienced by a user of the client device. These events are provided to a technical assistance specialist as an event log which may be analyzed by automated tools to deduce the most probable source of the problem complained of. In addition, this event log may be used to emulate the operating environment of the client device to obtain an understanding of what the user of the client device is experiencing.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing event information to a technical assistance specialist, comprising:
recording one or more events that occur in a first computing device associated with a user in an event log;
uploading the event log to a server;
retrieving, by a second computing device associated with the technical assistance specialist, the event log from the server; and
analyzing the event log to determine a probable source of technical difficulty, wherein analyzing the event log includes one or more of:
determining if there are any error events in the event log and identifying a probable source of the error event based on a type of error event present in the event log; and
comparing one or more event patterns to a sequence of one or more events in the event log, determining if an event pattern of the one or more event patterns matches the sequence of one or more events in the event log, and identifying a probable source of technical difficulty based on the event pattern if the event pattern matches the sequence of one or more events in the event log.

2. The method of claim 1, wherein analyzing the event log includes:
emulating an operating environment of the first computing device;
emulating a sequence of one or more events in the event log within the emulated operating environment; and
outputting the emulated operating environment and emulated sequence of events on the second computing device.

3. The method of claim 1, wherein recording one or more events that occur in the first computing device includes:
detecting the occurrence of an event using an event listener in the first computing device; and
generating, by the event listener, an event log entry corresponding to the event, wherein:
the event listener is one of an action listener, a window listener, a mouse listener, a mouse motion listener, a component listener, a focus listener, a list selection listener, and an error event listener, and
the event log entry includes at least one of an event identifier, an identifier of a source of the event, a timestamp, and one or more identifiers of associated operating environment components.

4. The method of claim 1, wherein uploading the event log to a server includes adding a user identifier to the event log prior to uploading, and wherein retrieving the event log from the server includes searching a plurality of event logs stored on the server based on the user identifier.

5. The method of claim 1, wherein identifying a probable source of the error event based on the type of error event includes retrieving an entry in an event database corresponding to the error event, wherein the entry includes information identifying at least one possible source of the error event and at least one suggested solution for the error event.

6. The method of claim 5, wherein the at least one possible source of the error event and at least one suggested solution include a plurality of possible sources of the error event and a plurality of corresponding suggested solutions, and wherein each possible source of the error event includes an associated event pattern that may be matched to an event pattern in the event log to determine which of the plurality of possible sources is the probable source of the error event.

7. The method of claim 1 further comprising:
outputting at least one suggestion for solving the technical difficulty in the first computing device based on the determined probable source of the technical difficulty.

8. A system for providing event information to a technical assistance specialist, comprising:
a client device;
a server coupled to the client device via at least one network; and
a technical assistance specialist computing device coupled to the server via the at least one network, wherein the client device records one or more events that occur in an event log and uploads the event log to the server, and wherein the technical assistance specialist computing device retrieves the event log from the server and analyzes the event log to determine a probable source of technical difficulty in the client device.

9. The system of claim 8, wherein the technical assistance specialist computing device analyzes the event log by determining if there are any error events in the event log and identifying a probable source of the error event based on a type of error event present in the event log.

10. The system of claim 8, wherein the technical assistance specialist computing device analyzes the event log by comparing one or more event patterns to a sequence of one or more events in the event log, determining if an event pattern of the one or more event patterns matches the sequence of one or more events in the event log, and identifying a probable source of technical difficulty based on the event pattern if the event pattern matches the sequence of one or more events in the event log.

11. The system of claim 8, wherein the technical assistance specialist computing device analyzes the event log by emulating an operating environment of the client device, emulating a sequence of one or more events in the event log within the emulated operating environment, and outputting the emulated operating environment and emulated sequence of events on the technical assistance specialist computing device.

12. The system of claim 8, wherein the client device records one or more events that occur in the first computing device by detecting the occurrence of an event using an event listener and generating, by the event listener, an event log entry corresponding to the event.

13. The system of claim 8, wherein the client device adds a user identifier to the event log prior to uploading the event log to the server, and wherein the technical assistance specialist computing device retrieves the event log from the server by sending a request to the server including a user identifier and the server searching a plurality of event logs stored on the server based on the user identifier.

14. The system of claim 9, wherein the technical assistance specialist computing device identifies a probable source of the error event based on the type of error event by retrieving an entry in an event database corresponding to the error event, wherein the entry includes information identifying at least one possible source of the error event and at least one suggested solution for the error event.

15. The system of claim 14, wherein the at least one possible source of the error event and at least one suggested solution include a plurality of possible sources of the error event and a plurality of corresponding suggested solutions, and wherein each possible source of the error event includes an associated event pattern that may be matched to an event pattern in the event log to determine which of the plurality of possible sources is the probable source of the error event.

16. A computer program product in a computer readable medium for providing event information to a technical assistance specialist, comprising:
first instructions for recording one or more events that occur in a first computing device associated with a user in an event log;
second instructions for uploading the event log to a server;
third instructions for retrieving, by a second computing device associated with the technical assistance specialist, the event log from the server; and
fourth instructions for analyzing the event log to determine a probable source of technical difficulty, wherein the fourth instructions for analyzing the event log include one or more of:
instructions for determining if there are any error events in the event log and identifying a probable source of the error event based on a type of error event present in the event log; and
instructions for comparing one or more event patterns to a sequence of one or more events in the event log, determining if an event pattern of the one or more event patterns matches the sequence of one or more events in the event log, and identifying a probable source of technical difficulty based on the event pattern if the event pattern matches the sequence of one or more events in the event log.

17. The computer program product of claim 16, wherein the fourth instructions for analyzing the event log includes:
instructions for emulating an operating environment of the first computing device;
instructions for emulating a sequence of one or more events in the event log within the emulated operating environment; and
instructions for outputting the emulated operating environment and emulated sequence of events on the second computing device.

18. The computer program product of claim 16, wherein the first instructions for recording one or more events that occur in the first computing device include:
instructions for detecting the occurrence of an event using an event listener in the first computing device; and
instructions for generating, by the event listener, an event log entry corresponding to the event, wherein:
the event listener is one of an action listener, a window listener, a mouse listener, a mouse motion listener, a component listener, a focus listener, a list selection listener, and an error event listener, and
the event log entry includes at least one of an event identifier, an identifier of a source of the event, a timestamp, and one or more identifiers of associated operating environment components.

19. The computer program product of claim 16, wherein the instructions for identifying a probable source of the error event based on the type of error event include instructions for retrieving an entry in an event database corresponding to the error event, wherein the entry includes information identifying at least one possible source of the error event and at least one suggested solution for the error event.

20. The computer program product of claim 16, further comprising:
fifth instructions for outputting at least one suggestion for solving the technical difficulty in the first computing device based on the determined probable source of the technical difficulty.
